(19) United States
(12) Patent Application Publication
(10) Pub. No.: US 2016/0350052 A1
(43) Pub. Date: Dec. 1, 2016

(54) BORDERLESS DISPLAY DEVICE

(71) Applicant: HON HAI PRECISION INDUSTRY CO., LTD., New Taipei (TW)

(72) Inventor: JEN-TSORNG CHANG, Tu-Cheng (TW)

(21) Appl. No.: 14/953,649

(22) Filed: Nov. 30, 2015

(30) Foreign Application Priority Data
May 29, 2015 (CN) 201510285130.9

(51) Int. Cl. G06F 3/14; G02B 5/02; G02B 3/00; G09G 3/3233; G09G 3/20

(52) U.S. Cl. CPC G06F 3/1446; G09G 3/3233; G09G 3/2003; G02B 3/005; G02B 5/0278; G09G 2300/026; G09G 2330/00

(57) ABSTRACT

A borderless display device includes at least two adjacent mosaic display screens with a mosaic border formed at a mosaic zone. The borderless display device also includes a border display bar to cover the mosaic border. The border display bar includes a power circuit board, a substrate layer, and a light emitting element pixel array with a plurality of light emitting element pixels disposed on the substrate layer. The light emitting element pixel array has a light exit surface away from the substrate layer, the substrate layer has multiple conductive vias, and the circuits of the power circuit board on opposite surfaces are electrically connective. The signal lines are electrically connected to the power circuit board through the conductive vias so that the signal lines are electrically connected to the surface of power circuit board away from the light exit surface.

### FIELD

The subject matter herein generally relates to a large-screen display technology, and more particularly to a borderless display device

### BACKGROUND

In the field of large-screen display applications, the conventional display size is limited by the size of glass and the manufacturing ability. A large-screen display is conventional fabricated by mounting a number of small-screen displays. This results in the discontinuity of the image due to the borders between the small-screen displays. A borderless large-screen display is needed for a seamless image.

### BRIEF DESCRIPTION OF THE DRAWINGS

Implementations of the present technology will now be described, by way of example only, with reference to the attached figures.

FIG. 1 is a diagrammatic view of a borderless display with internal function modules according to a first embodiment.

FIG. 2 is a diagrammatic view of the borderless display device in FIG. 1 with a plurality of display screens.

FIG. 3 is a diagrammatic view of the borderless display device in FIG. 2 including a plurality of border display bars to cover the borders.

FIG. 4 is a diagrammatic, cross-sectional view of border display bars of the borderless display device in FIG. 3.

FIG. 5 is a diagrammatic view of the border display bar of the borderless display device in FIG. 4 with a plurality of light emitting element pixels.

FIG. 6 is a diagrammatic view of the border display bar of the borderless display device in FIG. 4 with a different array pattern of the light emitting element pixels.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

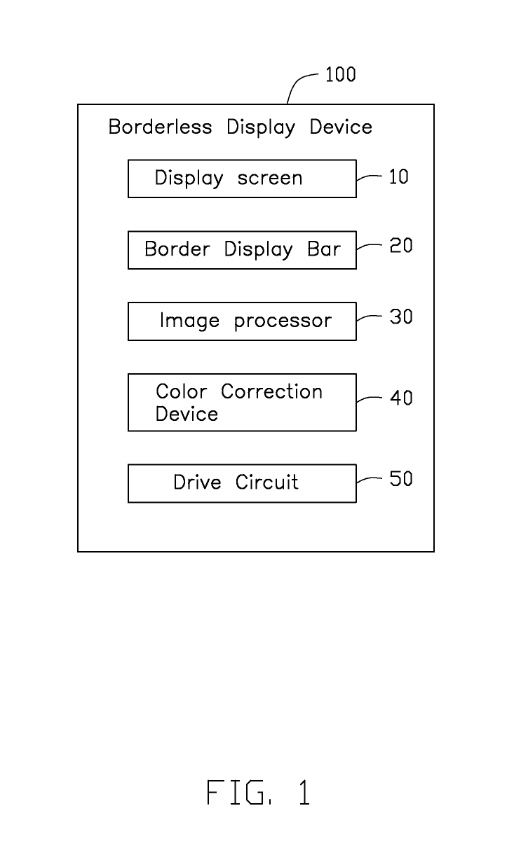

FIG. 1 illustrated a borderless display device 100 includes a plurality of display screens 10, a border display bar 20, an image processor 30, a color correction device 40, and a drive circuit 50.

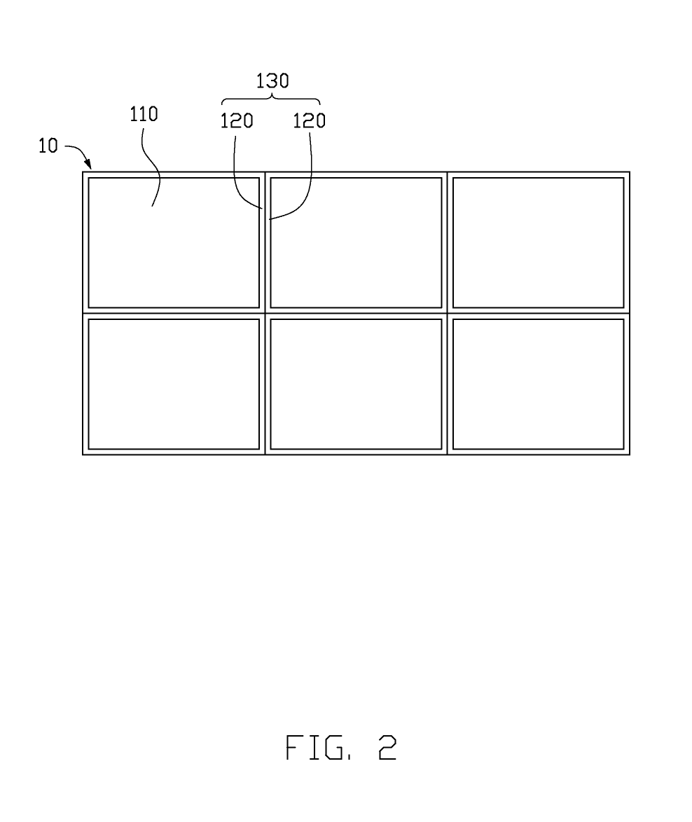

FIG. 2 illustrates each of the display screens 10 includes a display area 110 and a border 120 surrounding the display area 110. A mosaic border 130 is formed by the two adjacent borders 120 of a mosaic zone. The display screen 10 may be a liquid crystal display, an organic light-emitting diode (OLED) display, a plasma display, a rear projection display, or a cathode ray tube display.

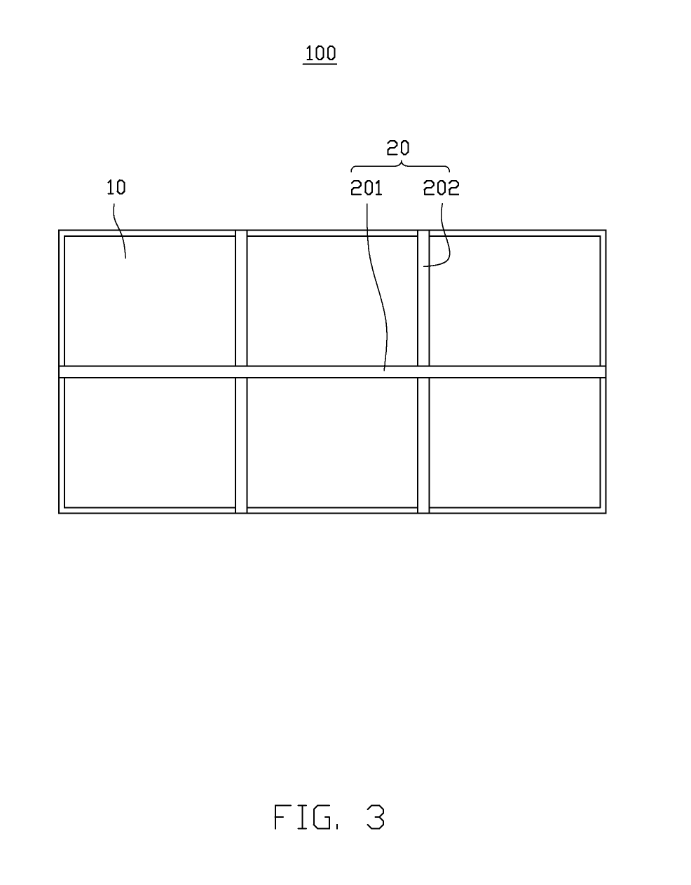

FIG. 3 illustrates the border display bar 20 covers the mosaic border 130. The border display bar 20 includes one horizontal border display bar 201 and four vertical border display bars 202.

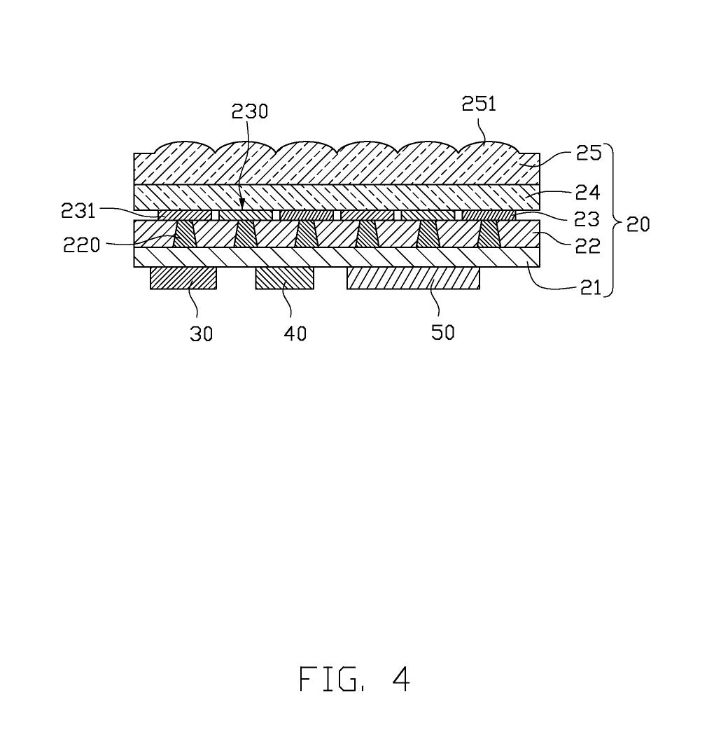

FIG. 4 illustrates the border display bar 20 includes a power circuit board 21, a substrate layer 22 disposed on the power circuit board 21, a light emitting element pixel array 23 disposed on the substrate layer 22, a diffuser sheet 24 disposed on the light emitting element pixel array 23, and a microlens array 25 disposed on the diffuser sheet 24. The light emitting element pixel array 23 comprises an array of light emitting element pixels 231. Each of the light emitting element pixels 231 has a light emitting surface. All of the light emitting surfaces are composed as a light exit surface 230 for the light emitting element pixel array 23.

The light emitting element pixel 231 emits one of the primary color lights which are red, green and blue. In at least one embodiment, when one of the light emitting element pixels 231 of the light emitting element pixel array 23 emits a red light, the other light emitting element pixels 231 surrounding the above light-emitting element pixel 231 can emit a green light or a blue light.

In at least one embodiment, the light emitting element pixel 231 is an organic light emitting diode (OLED). The light emitting element pixel 231 can be an active matrix OLED (AMOLED) or a passive matrix organic light emitting diode (PMOLED). Each of the light emitting element pixels 231 includes a plurality of control signal lines (not shown) disposed on a surface of the light emitting element pixel 231 away from the light exit surface 230.

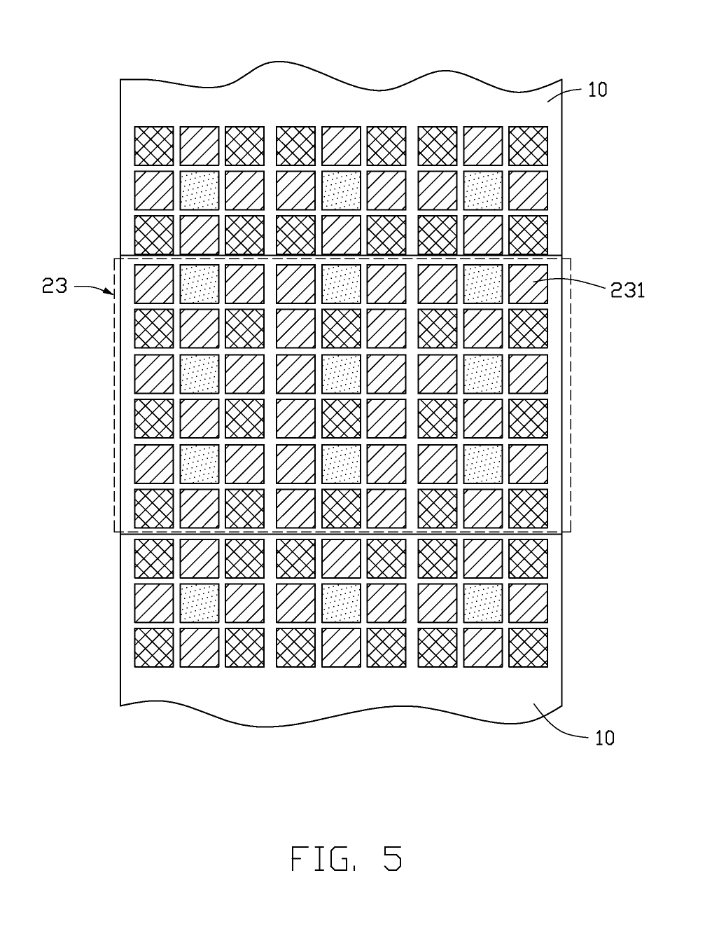

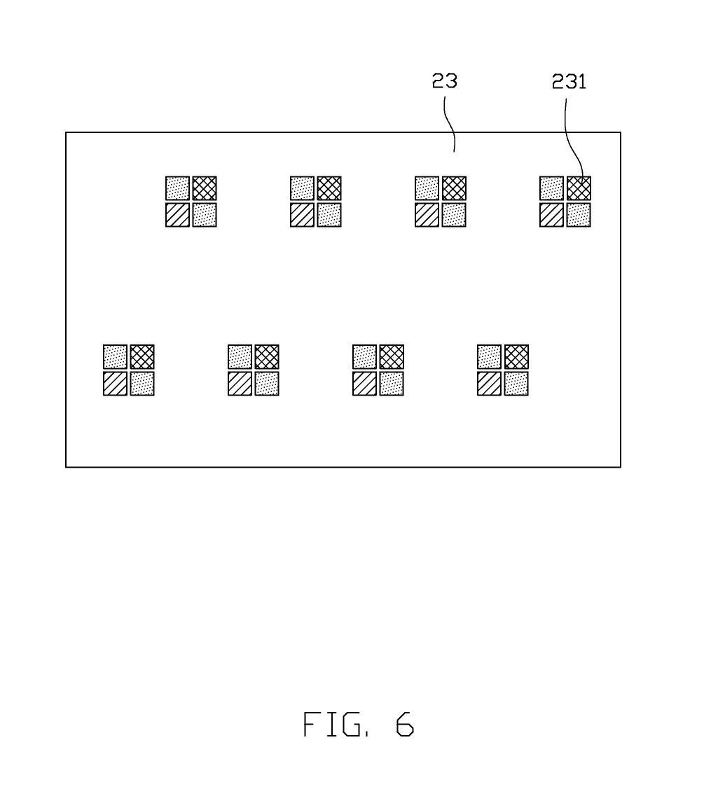

FIG. 5 and FIG. 6 illustrate different arrangements of the light emitting element pixels 231 of the light emitting element pixel array 23. The arrangements of light emitting element pixels 231 in the light emitting element pixel array can be a matrix with a plurality of light emitting element pixels 231 or a matrix with a plurality of grouped light emitting element pixels 231. In other embodiments, the arrangement of the light emitting element pixels 231 in the light emitting element pixel array 23 can be arranged according to the actual needs of the light emitting element pixel array 23.

FIG. 4 illustrates the power circuit board 21 can be a double-layer circuit board or a multi-layer circuit board. The circuits on the opposite surfaces of the power circuit board 21 are electrically connected. In at least one embodiment, the power circuit board 21 is made of alumina to evenly dissipate the heat of the border display bar 20.

The substrate layer 22 has a plurality of conductive vias 220. The light emitting element pixel array 23 disposed the substrate layer 22 is electrically connected to the power circuit board 21 through the conductive vias 220 so that the signal lines (not shown) of light emitting element pixel array 23 are guided to the power circuit board 21 through the conductive vias 220. Since the circuits on the opposite surfaces of the power circuit board 21 are electrically connected, the signal lines of the light emitting element pixel array 23 can be guided to the surface of the power circuit board 21 away from the substrate layer 22.

As mentioned above, each light emitting element pixel 231 includes a plurality of control signal lines disposed on the surface of the light emitting element pixel 231 away from the light exit surface 230. The control signal lines of the light emitting element pixel 231 include a gate line (or a scanning line) and a data line. The gate line provides the row-selective turn-on scanning signals and the data line provides the column-selective data signals for the image pixel. During operation, the scanning signals and the data signals are simultaneously electrically connected to a thin film transistor (TFTs) which is electrically connected to a corresponding light emitting element pixel 231. The control of the operating electrical current of light emitting element pixel 231 is realized through controlling the turn-on or cut-off of the corresponding TFT. Therefore, the light emitting element pixel 231 emits the primary color light to display an image within a controllable time frame.

The diffuser sheet 24 disposed on the light emitting element pixel array 23 is used to diverge the light for obtaining a uniform light. The diffuser 24 is also used to reduce the hot-spots phenomenon of the light emitting element pixel array 23 in the border display bar 20.

The microlens array 25 disposed on the diffuser sheet 24 is used for protecting the border display bar 20. The microlens array 25 comprises an array of lenses 251 disposed on a surface of the microlens array 25 away from the light emitting element pixel array 23. The number of the lenses 251 is consistent with the number of the light emitting element pixels 231 in the light emitting pixel array 23, and the positions for each lens 251 is corresponding to the positions for each of the light emitting element pixels 231. The lens size for each lens 251 is comparable to the pixel size of the display screen 10. Therefore, the microlens array 25 makes the border display bar 20 and the display screen 10 have almost the same resolution. The users can observe a seamless integrated image from the borderless display device 100.

In other embodiments, the border display bar 20 further includes an optical filter disposed between the light emitting element pixel array 23 and the diffuser sheet 24. The optical filter is used to eliminate stray light.

The image processor 30 is electrically connected to each border display bar 20 and the display screens 10. The image processor 30 divides the image signals into multiple sections and separately transfers the corresponding sections to the display screens 10 and the border display bar 20 for displaying the image. In at least one embodiment, the image processor 30 divides the image into 11 sections for the six display screens 10 and the border display bar 20 which includes one horizontal border display bar 201 and four vertical border display bars 202. There is no overlapping image between the horizontal border display bar 201 and the four vertical border display bars 202. Therefore, the horizontal border display bar 201 and the four vertical border display bars 202 can independently display the image without any crossover.

The color correction device 40 is used for correcting display colors of the border display bar 20. After correction, the display colors of the border display bar 20 and the display screens 10 are almost the same.

The drive circuit 50 is disposed on a surface of the power circuit board 21 away from the substrate layer 22. As mentioned above, the signal lines of the light emitting element pixel 231 are electrically connected to the power circuit board 21 through the conductive vias 220, the circuits on opposite surfaces of the power circuit board 21 are electrically connected, and the drive circuit 50 is disposed on the surface of the power circuit board 21 away from the substrate layer 22. Therefore, the light emitting element pixel 231 and the drive circuit 50 are electrically connected through the conductive vias 220 of the substrate layer 22 to avoid the dark regions generated by arranging the drive circuit 50 and the signal lines of each of the light emitting element pixels 231 on a side of the light emitting element pixel array 23. The drive circuit 50 is also electrically connected to the image processor 30 to receive the instructions sent from the image processors 30, and drives the border display bar 20 and the display screens 10 to display the image.

In summary, the borderless display device 100 includes a border display bar 20 on the mosaic border 130 to cover the mosaic border 130. The border display bar 20 includes the power circuit board 21, the substrate layer 22, the light emitting element pixel array 23, the diffuser sheet 24, and the microlens array 25. The light emitting element pixel array 23 comprises an array of light emitting element pixels 231. Each of the light emitting element pixels 231 has a light emitting surface. All of the light emitting surfaces are composed as the light exit surface 230. The signal lines and control circuits of the border display bar 20 are not positioned at a side of the border display bar 20. The signal lines and control circuits of the border display bar 20 are arranged on a surface away from the light exit surface 230 to avoid generating the dark regions and to reduce the weight and cost of the borderless display device 100.

The embodiments shown and described above are only examples. Many details are often found in the art such as the other features of a borderless display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A borderless display device comprising:
at least two adjacent mosaic display screens with a mosaic boarder, the mosaic boarder is formed by the adjacent mosaic display screens at a mosaic zone; and
a border display bar covering the mosaic border, the border display bar comprising:
a power circuit board;
a substrate layer disposed on the power circuit board, the substrate layer having a plurality of conductive vias; and
a light emitting element pixel array disposed on the substrate layer, the light emitting element pixel array comprising a plurality of light emitting element pixels, each of the light emitting element pixels has a light emitting surface and a plurality of signal lines, all of the light emitting surfaces are composed as a light exit surface;
wherein the signal lines of the light emitting element pixel is electrically connected to the power circuit board through the conductive vias, and the signal lines of the light emitting element pixel are guided to a surface of the power circuit board away from the light exit surface.

2. The borderless display device of claim 1, wherein the borderless display device further comprises an image processor, the image processor is electrically connected to the border display bar and each of the display screens, the image processor divides image signals into multiple sections and separately transfers the corresponding sections to the display screens and the border display bar to display the image.

3. The borderless display device of claim 1, wherein the borderless display device further comprises a driving circuit, the driving circuit is disposed on a surface of the circuit board away from the substrate layer.

4. The borderless display device of claim 1, wherein the light emitting element pixel is an organic light emitting diode (OLED), the OLED is selected from an active matrix organic light emitting diode (AMOLED) or passive matrix organic light emitting diode (PMOLED).

5. The borderless display device of claim 1, wherein the border display bar further comprises a microlens array disposed on the light emitting element pixel array.

6. The borderless display device of claim 5, wherein the microlens array comprises an array of lenses formed on the surface of the microlens array away from the light emitting element pixel array, the numbers of the lenses and the light emitting element pixels are the same, and the positions for each lens is corresponding to the positions for each of the light emitting element pixels.

7. The borderless display device of claim 6, wherein the lens sizes for each lens are substantially same as the pixel sizes of the display screens.

8. The borderless display device of claim 5, wherein the borderless display device further comprises a diffuser sheet disposed between the light emitting element pixel array and the microlens array.

9. The borderless display device of claim 8, wherein the borderless display device further comprises an optical filter disposed between the light emitting element pixel array and the diffusion sheet.
